(19) United States
(12) Patent Application Publication
(10) Pub. No.: US 2025/0093181 A1
(43) Pub. Date: Mar. 20, 2025

(54) TUBE MOVEMENT MEASURING SYSTEM AND METHOD

(71) Applicants: Glen Stapleton, Springfield, VA (US); Julian Stapleton, Springfield, VA (US)

(72) Inventors: Glen Stapleton, Springfield, VA (US); Julian Stapleton, Springfield, VA (US)

(21) Appl. No.: 18/887,838

(22) Filed: Sep. 17, 2024

Related U.S. Application Data
(60) Provisional application No. 63/539,212, filed on Sep. 19, 2023.

(51) Int. Cl. G01D 5/02; B21C 51/00

(52) U.S. Cl. CPC G01D 5/02; B21C 51/00; G01D 2205/90

(57) ABSTRACT

A system and method for measuring tube movement through a tube altering machine includes a first sensor device for detecting a rotational movement of the tube caused by the tube altering machine as the tube passes therethrough. A second sensor device detects a linear movement of the tube caused by the tube altering machine as the tube passes therethrough. These precise measurements are achieved without marking or damaging the tube material and can be compared to anticipated measurements to determine if machine settings should be altered.

### RELATED APPLICATIONS

This application claims the benefit of U.S. Provisional Application Ser. No. 63/539,212, filed: Sep. 19, 2023.

### FIELD OF THE INVENTION

The present invention generally relates to measuring the linear and rotational movement of a tube through a pilger mill or tube reducer machine. More particularly, the present invention is related to a system and method that measures the linear and rotational movement of the tube precisely without damaging the tube.

### BACKGROUND OF THE INVENTION

There exist machines and processes for forming or altering tubes, particularly metal tubes, for example a pilger mill or tube reducer that cold reduces the outside diameter and tube wall of a tube on an ongoing mode. These machines can reduce large amounts of tube area comparatively to a cold draw machine. A pilger mill or tube reducer cold works various alloys such as steel, copper and aluminum.

The pilger mill or tube reducer machine forces the tubes to rotate. If the tube does not rotate the tube correctly at the proper angle, the machine will make unacceptable defects on the tubes. The current method of measuring the actual tube movement as it exits the machine is to manually mark the tube. This is typically done with a scratch from a sharp pin or scribe in addition to a marking, such as a colored dot, which are made on the tube to show a single stroke of the machine.

However, the current methodology has several drawbacks. The machine must be in operation for the measurement (scratch) to be made. The scratch is intended to show the feed rate elongation of the tube being reduced and the turning angle of the finished tube. However, it is not accurate as one can only measure the scratch made on the tube. Moreover, all scratched tubes are scrapped because of the damaging scratch. This can be very expensive because of the resulting scrap material.

Accordingly, there is a continuing need for a system or method which compares the machine settings that project a tube quality to the actual precise measurements of the tube products as they are passed through the machine. Such a system or method should provide precise results without damaging the tube material. The present invention fulfills these needs and provides other related advantages.

### SUMMARY OF THE INVENTION

The present invention resides in a system and method for measuring tube movement through a tube altering machine so as to obtain precise measurement of the tube as it is passed through the machine, enabling the comparison of the precise measurements to anticipated measurements according to machine settings to ensure tube quality without damaging the tube material.

In accordance with a method for measuring tube movement through a tube altering machine, a rotational movement of the tube caused by the tube altering machine is detected as the tube passes through the tube altering machine over a predetermined period of time. Linear movement of the tube caused by the tube altering machine as the tube passes through the machine over the predetermined period of time is also detected. It is determined whether adjustments should be made to the tube altering machine by comparing the detected rotational movement and linear movement of the tube over the predetermined period of time to an anticipated rotational movement and linear movement of the tube over a predetermined period of time, such as in accordance with the machine settings. The predetermined period of time may be relatively short, such as between one second and one minute.

The rotational movement may be detected by associating a rotational sensor device with the tube to detect rotational movement of the tube. The rotational sensor device may comprise an electro-mechanical device. For example, the rotational sensor device may comprise a driver roller positionable onto a surface of the tube and an encoder operably associated to the driver roller.

The step of detecting linear movement of the tube may comprise the step of associating a linear sensor device to measure the linear movement of the tube. The linear sensor device may comprise an electro-mechanical device. For example, the linear sensor device may comprise a retractable cable coupled to the tube and which extends from a fixed linear encoder as the tube is moved linearly. A linear roller may be coupled to the retractable cable and the tube and which is caused to roll as the tube is moved, causing the cable to be extended from the encoder device.

A system for measuring tube movement through a tube altering machine in accordance with the present invention comprises a first sensor device associated with the tube moving through the tube altering machine that detects a rotational movement of the tube caused by the tube altering machine. A second sensor device associated with the tube moving through the tube altering machine detects a linear movement of the tube caused by the tube altering machine. Typically, the first sensor device detects rotational movement of the tube and the second sensor device detects linear movement of the tube over a predetermined period of time. Such predetermined period of time may comprise between one second and one minute.

The first and second sensor devices are communicatively coupled to an electronic device that can determine if the detected rotational and/or linear movement of the tube through the tube altering machine differs from an expected rotational and/or linear movement of the tube over a predetermined period of time, such as in accordance with machine settings and/or a preferred or necessary linear and rotational movement of the tube.

The first sensor device may comprise an electro-mechanical device. For example, the first sensor device may comprise a driver roller engageable with the surface of the tube and a first encoder associated with the driver roller that detects rotation of the driver roller caused by rotation of the tube. A supporting roller may be engageable with the surface of the tube in spaced relation to the driver roller for supporting the tube between the support roller and the driver roller. A clamping device may be used to selectively bring the driver roller into engagement with the surface of the tube.

The second sensor device may comprise an electro-mechanical device. For example, the second sensor device may comprise a linear encoder device coupled to the tube so as to detect a linear distance the tube travels over a predetermined period of time. The linear encoder device may include a retractable cable that extends from the encoder as the tube moves linearly. The linear encoder device may be operably coupled to a vertical roll assembly, including a linear roller, that detects linear movement of the tube. A linear encoder housing may be in fixed position relative to the tube and include a retractable cable extendable from the linear encoder housing as a linear roller rotates in response to a linear movement of the tube. The linear roller may be spaced apart from the tube and attached to an arm that is coupled to the tube.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a rear perspective view of components comprising a system embodying the present invention;

FIG. 2 is a front perspective view of the system of FIG. 1, illustrating encoders of the present invention in electronic communication with an electronic device, in accordance with the present invention;

FIG. 3 is a perspective view of the system of the present invention positioned with respect to a tube and a feed bed of a tube altering machine, in accordance with the present invention;

FIG. 4 is a front partially sectioned view of components of the system of the present invention being positioned with respect to a tube, in accordance with the present invention;

FIG. 5 is a front and partially sectioned view similar to FIG. 4, illustrating engagement of rollers of the system of the present invention with the tube, in accordance with the present invention;

FIG. 6 is a partially sectioned perspective view illustrating the system of the present invention positioned with respect to a tube and a feed bed of a tube adjusting machine; and

FIG. 7 is a view similar to FIG. 6, but illustrating movement of rotational and linear rollers of the system as the tube is rotationally and linearly moved by the machine to detect and measure the amount of rotational and linear movement of the tube as it is passed through the machine.

### DETAILED DESCRIPTION OF THE PREFERRED EMBODIMENTS

As shown in the accompanying drawings, for purposes of illustration, the present invention is directed to a system and method used to detect and measure the linear and rotational movement of a tube passing through a tube altering machine, such as a pilger mill or tube reducer, so as to measure the linear and rotational movement of the tube as it passes through the machine over a predetermined period of time and/or per machine stroke. The system and method of the present invention does this very precisely without marring or damaging the tube. Such measurements can be compared to the anticipated linear and rotational movement of the tube and adjustment to the machine setting may be made as needed.

The pilger mill or tube reducer or the like machine forces the tubes to rotate as the tube passes through the tube altering machine. If it does not rotate correctly at the proper angle, it will make unacceptable defects on the tubes. Thus, an objective of the present invention is to measure the amount of linear movement as well as the amount of rotational movement of the tube over a predetermined period of time, which may correspond to a machine stroke, which may be one revolution of the machine crankshaft. The present invention incorporates sensors or the like which measure both the rotational and linear movement of the tube as it is passes through the machine, without scratching or marking the tube, and thus there is no need to scrap the tube that is created, enabling the user to obtain important operational information of the machine without creating scrap material. Moreover, the system and method of the present invention provides actual precise measurements of the tube as it is passed through the machine, which measurements can be compared to the anticipated rotational and linear movement of the tube according to machine settings. In some cases, the machine settings will need to be adjusted to achieve the desired results.

In accordance with the present invention, a method for measuring tube movement through a tube altering machine comprises the steps of detecting a rotational movement of the tube caused by the tube altering machine as the tube passes therethrough over a predetermined period of time, such as one or more machine strokes. The present invention also detects a linear movement of the tube caused by the tube altering machine as the tube passes therethrough over the predetermined period of time. Typically, as these detections and measurements occur simultaneously. Typically, the linear and rotational movement of the tube as it passes through the machine is done relatively quickly, such as between one second and one minute, and typically thirty seconds or less. This time typically corresponds to one or more machine strokes, such as one or more revolutions of the machine crank shaft, which causes the machine to both rotate the tube and move it linearly. Sensors or sensor devices are used in accordance with the system and methodology of the present invention in order to detect the rotational and linear movement of the tube, so as obtain measurements of these movements. Such sensors may be optical, electrical, electro-mechanical or even mechanical. In the system illustrated and described herein, the sensing devices are a combination of mechanical and electrical so as to comprise electro-mechanical devices.

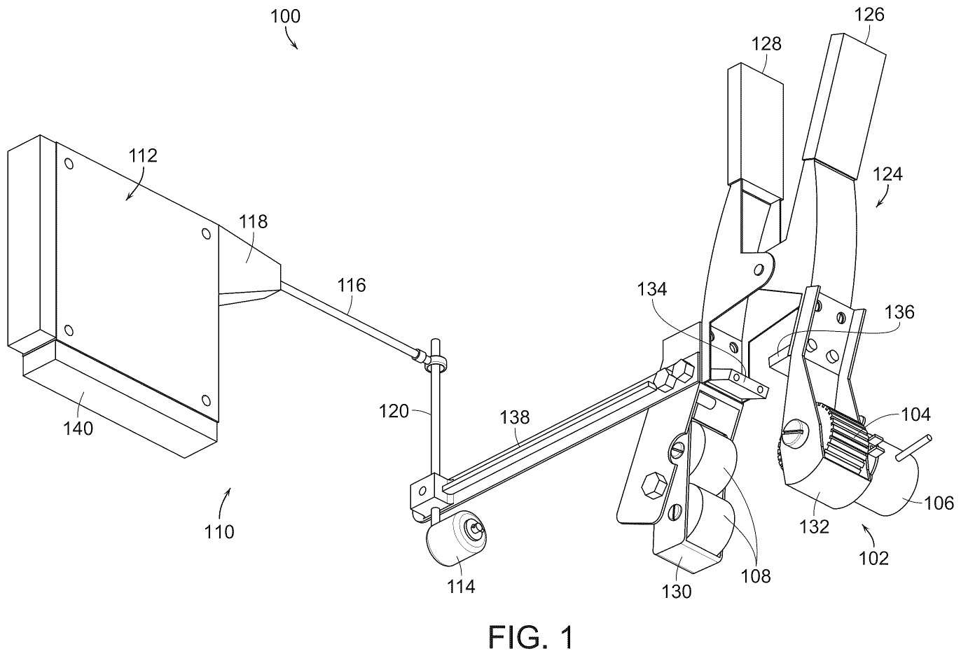

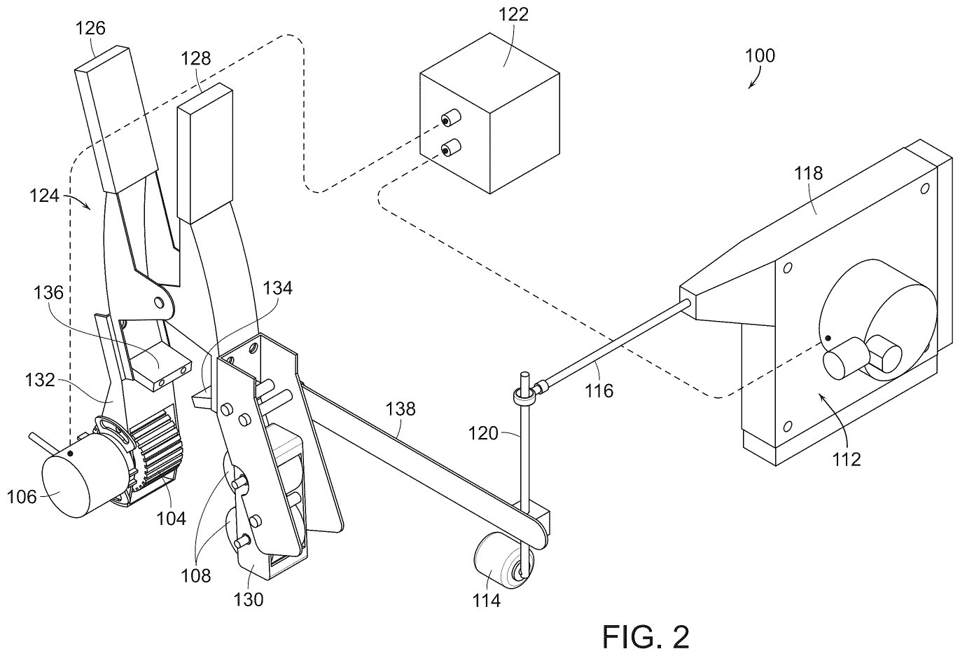

With reference now to FIGS. 1 and 2, an exemplary system 100 embodying the present invention is shown. The system 100 includes a first sensor device 102, which may comprise, as illustrated, a drive roller 104 positionable against a surface of a tube 10 passing through a tube altering machine 12. When in contact with the tube, the driver roller 104 is rotated as the machine 12 rotates the tube 10. Such rotational movement is detected by a first or rotational encoder 106. The encoder 106 may comprise an optical device, an accelerometer, or any other sensor, device or encoder which is capable of being associated or coupled with the driver roller 104 so as to detect and measure the rotation of the driver roller 104, which corresponds with the rotation of the tube 10. As such, the first sensor device 102 is an electro-mechanical device in that the driver roller 104 has a mechanical and physical contact with the tube 10 and the rotation encoder 106 is electrical or electronic in nature and in combination with the driver roller 104 detects or measures the rotation of the tube 10 as it passes through the machine 12. One or more freely rolling support rollers 108 may also be engageable with the surface of the tube 10 in spaced relation to the driver roller 104 for supporting the tube between the one or more support rollers 108 and the driver roller 104.

With continuing reference to FIGS. 1 and 2, a second sensor device 110 is used to measure the linear movement of the tube 10 as it passes through the machine 12. The second sensor device 110 in the illustrated embodiment includes a second, linear encoder 112 which is operably associated with our coupled to a linear roller 114, which rotates and rolls as the tube 10 is moved linearly within the machine 12. In the illustrated embodiment, a cable 116 is retractably extendable from the encoder 112, such as from a housing 118 of the encoder. An end of the cable 116 is operably coupled to the linear roller 114, such as by means of post 120. As the linear roller 114 is rotated and moved linearly, the post 120 moves with the roller 114, and thus pulls the cable 116 from the linear encoder 112. The linear roller 114 is operably coupled to the tube 10 such that as the tube moves linearly, the linear roller 114 is caused to rotate and roll linearly by a corresponding distance. It will be appreciated that instead of a cable 116, a secondary rotary encoder, such as an accelerometer or the like may be used to measure the linear movement of the tube over a predetermined period of time or machine stroke as the linear roller 114 is rotated and moved.

The components of the system of the present invention may be permanently installed on the machine 12, such as the entry side and/or the exit side of the machine. The sensor devices, as described above, could be used to selectively measure the linear and rotational movement of a tube as it is passed through the machine 12. The first and second sensing devices will sense the rotational and linear movement of the tube 10 as it passes through the machine 12. For example, driver roller 104 is moved into engagement with a surface of the tube 10 and the linear roller 114 is coupled to the tube 10 such that as the tube rotates the driver roller 104 is rotated and as the tube moves linearly, the linear roller 114 is moved and rotates. This is typically done for a short period of time, typically one minute or less, and perhaps for only a few seconds, such as thirty seconds or less. This predetermined period of time typically corresponds with one or more machine strokes of the machine, which causes the tube to both rotate and move linearly.

The detected rotational and linear measurements may be sent to an electronic device, such as a controller or computer, which may be part of the machine 12 or a separate electronic device, such as a handheld device, laptop, desktop or the like. Such signals and information may be conveyed by means of wired communication coupling or wireless transmission to such an electronic device 122. The electronic device 122 can then compare the readings from the first and second sensor devices of the system of the present invention to detect and measure the actual rotational linear movement of the tube 10 per machine stroke, such as over a course of a predetermined period of time, compared to an anticipated measurement of the values. If these values do not match, the machine settings may be altered as needed so that the tube 10 is formed as desired. Such information may be conveyed to the operator of the machine, management, and such machine setting adjustments may be performed either automatically or after such data has been reviewed by the operator, management, etc.

While the system of the present invention may be permanently attached to or built into the tube altering machine 12, it may instead be a portable unit which is manually and selectively attached to the tube 10 and/or machine 12, as is shown in the embodiment illustrated herein. This portable embodiment comprises a clamp 124 having handle members 126 and 128 at one end thereof and attachment and holding means at generally opposite ends thereof 130 and 132 for the driver roller 104 and other rollers 108, etc. The clamp 124 is biased in a closed position, wherein rollers 104 and 108 are moved or biased towards one another. The rollers 104 and 108 are rotatably connected to ends of the clamp 130 and 132, as illustrated. In this manner, the tube 10 is able to rotate between the support rollers 108 and the driver roller 104 when these rollers 104 and 108 are engaged with the tube 10. Clamp stops 134 and 136 may be used to prevent the rollers 104 and 108, or other components or structure of the ends 130 and 132 of the clamp 124 from coming into contact with one another. Arm 138 extends between the clamp 124 and the linear roller 114, and more typically post 120, such that as the tube 10 is moved linearly, the clamp 124, which is clamped thereon, will move linearly, and thus causing the arm 138, and thus the linear roller 114 to correspondingly move linearly.

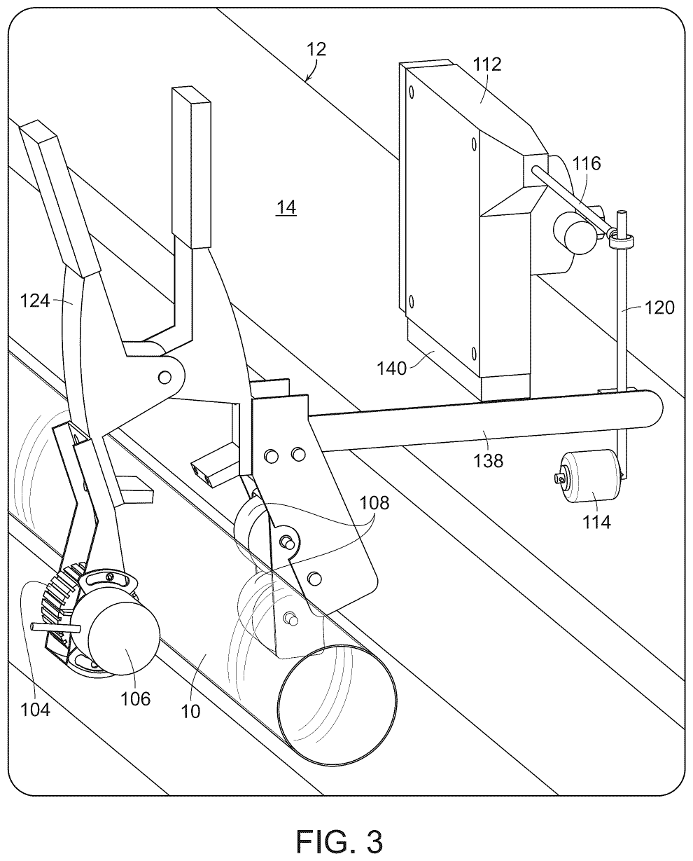

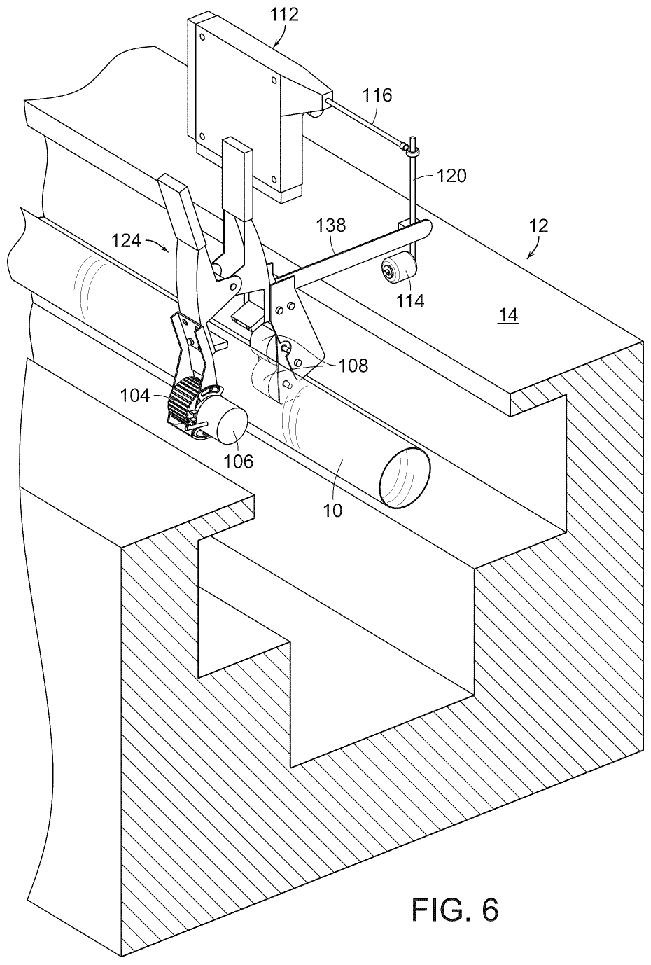

With reference now to FIGS. 3-5, in use of the portable assembly 100, as illustrated herein, comprises affixing the linear encoder 112 to the machine 12, such that it is held fixedly in place. This may be accomplished, for example, utilizing a magnet 140 at the base of the encoder 112 which is magnetically attached to a surface 14 of the machine 12. Cable 116 is operably coupled to the linear roller 114, such as by attachment to post 120. Linear roller 114 is engaged with and able to roll along and move linearly on a surface, such as surface 14 of the machine 12, typically the feed bed of the machine.

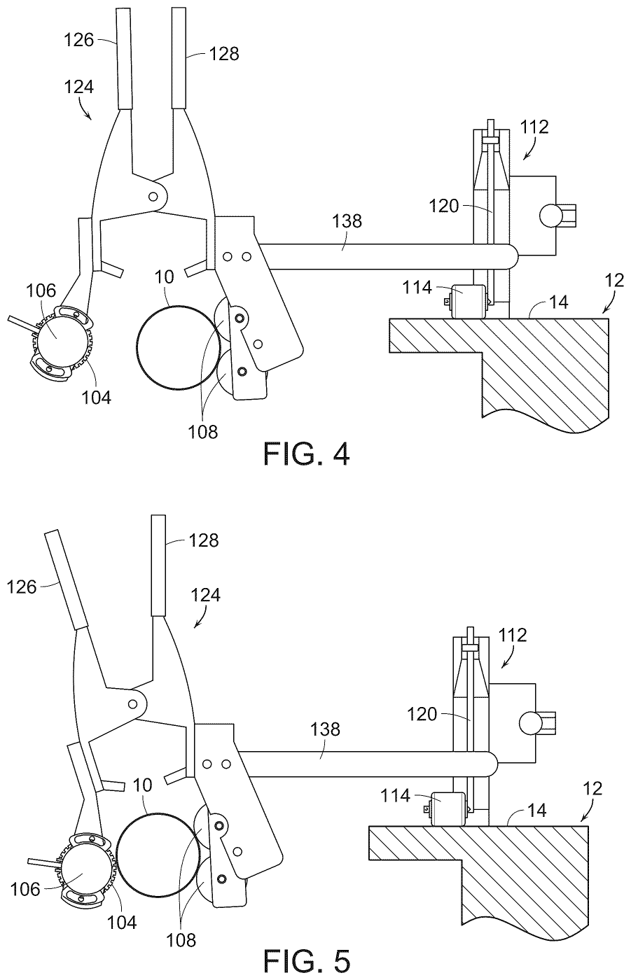

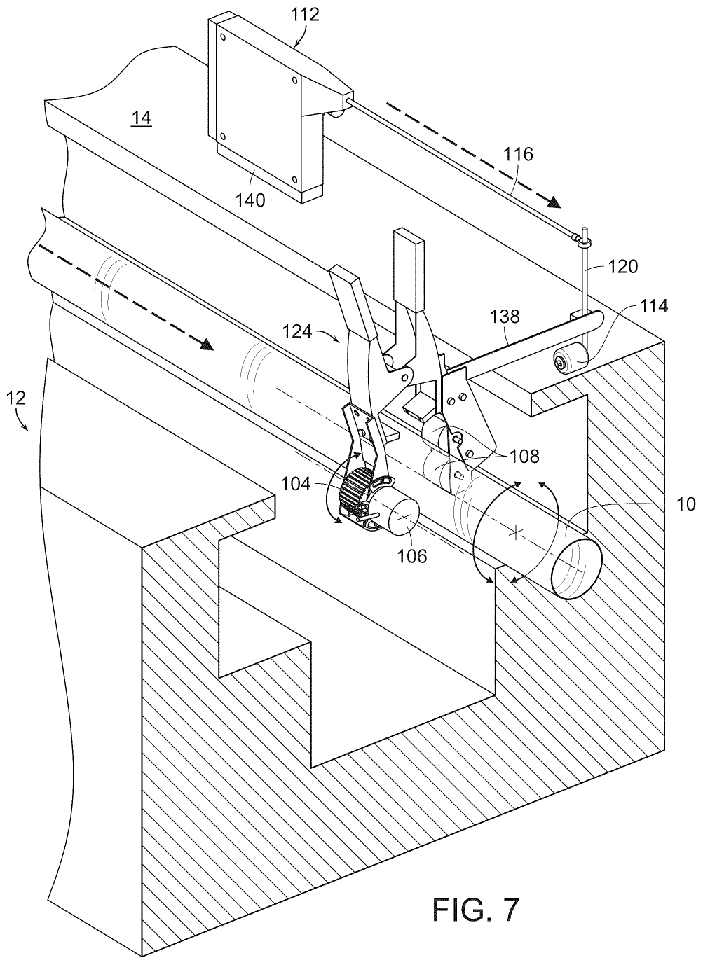

Clamp 124 is actuated so as to bring rollers 104 and 108 into engagement with the surface of tube 10. This may be done by moving handles 126 and 128 towards one another, as illustrated in FIG. 4, so as to move apart rollers 104 and 108, until they are properly positioned over the outer surface of tube 10, after which the handle members 126 and 128 may be allowed to be biased away from one another, bringing rollers 104 and 108 into contact with the surface of tube 10, as illustrated in FIGS. 3, 5 and 6. Arm 138 extends from the clamp to the linear roller 114, such as being coupled to post 120. Thus, as the clamp is engaged with tube 10, as the tube 10 is moved linearly the clamp will likewise move linearly along with the tube, causing linear roller 114 to be moved and rolled along surface 114.

With reference to FIG. 7, with the components of the system 100 of the present invention in place, driver roller 104 and support rollers 108 engaging tube 110, the second linear encoder 112 being in a fixed position and linear roller 114 being attached to clamp 124 and also cable 116, the machine is then powered on 12, causing the tube 10 to be moved both rotationally and linearly, as shown by the arrows in FIG. 7. When the machine causes the tube 10 to be rotated, such rotational movement causes driver roller 104 to also be rotated, as shown by the arrows, which rotational motion is detected and measured by rotational encoder 106. The machine 12 also linearly moves tube 10. As the clamp 124, and its associated components, are coupled to the tube 10, linear movement of the tube causes a corresponding linear movement of the clamp 124 and these components. Such linear motion is transferred from arm 138 to the linear roller 114. This may be done via the connection of the arm 138 to post 120. This causes the linear roller 114 to rotate and move linearly, thus causing the post 120 to move linearly and cable 116 to be extended from the second linear encoder 112. The fixed in place linear encoder 112 is able to detect and measure the amount of linear movement of the tube 10 by virtue of the extension of cable 116.

The first and second sensor devices of the system of the present invention detect and measure both the rotational and linear movement of tube 10 for a predetermined period of time. This is typically a relatively short period of time, such as a minute or less and may be as little as a second, but typically thirty seconds or less, such as a few seconds. Such predetermined period of time may correspond with a single stroke or cycle of the machine 12 or a predetermined number of strokes or cycles of the machine 12. The machine settings are set to rotate the tube 10, at a particular angle or rotational movement, a well as a linear movement of the tube 10 over a predetermined period of time and/or per stroke of the machine 12 so as to yield anticipated results of the altering of the tube 10, such as reducing the diameter of the tube in the case of a tube reducing or pilger machine or the like. If these settings are not precisely accurate, the resulting alteration of the tube 10 will not be accurate.

Thus, as discussed in connection with FIG. 2, the actual detected measurements of the rotation of the tube 10, such as provided by the first sensor device of driver roller 104 and corresponding first rotational encoder 106 and the second, linear encoder 112, such as by means of extension of cable 116 by the rotation and linear travel of linear roller 114, provides a very precise and accurate actual measurement of the rotational movement and linear movement of the pipe 10 over the predetermined period of time and/or one or more strokes of the machine. This detected and measured information is provided to the electronic device 122. The electronic device 122 may comprise electronic circuitry or an internal computer or computer associated with the machine 12 itself. Alternatively, the electronic device 122 may comprise a desktop computer, laptop, or handheld computer, such as a smartphone, tablet or the like. Such electronic device 122 is capable of receiving and reading such signals from the encoders 106 and 112 and comparing them to the anticipated measurements given the machine settings. If these match, or are within a tolerable range, then no adjustments to the machine settings are necessary. However, if this is not the case, and the actual detected and measured rotational and linear movement of the tube 10 as it is passed through the machine 12 while the system of the present invention is in operation do not match those of the machine settings, the operator of the machine and/or management of the manufacturing company may modify the settings of the machine 12 so as to produce the exact desired results.

Typically, the system and method of the present invention are performed for a relatively short period of time, such as at the beginning startup of the machine 12. This may be for anywhere from a second to a minute, and typically thirty seconds or less, such as only a few seconds. Such predetermined period of time may correspond with one or more strokes of the machine, which cause the rotational and linear movement of the tube 10 as it passes through the machine so as to be altered, such as being reduced in diameter. After this predetermined period of time, which may correspond to one or more strokes of the machine, the system 100 of the present invention is disengaged and no longer measures the movements of the tube 10. In the case when the system 100 of the present invention is permanently built into or attached to the machine 12, such may be powered off, automatically decoupled from the tube 10 or manually decoupled from the tube 10. In the case of the portable embodiment illustrated herein, the system 100 of the present invention may be decoupled from the tube 10 and the machine 12 by reversing the steps mentioned above. This includes actuating clamp 124 so as to remove it, and associated driver roller 104 and support rollers 108 from the tube 10. Second, linear encoder 112 is detached from the surface 14, as are its associated components, including cable 116, linear roller 114 and post 120.

The system 100 and methodology of the present invention may be performed as needed. This may include when the machine 12 is initially set up for operation. The system 100 and methodology of the invention 100 may be used periodically to ensure that the machine settings are correct. The system 100 and methodology of the present invention may also be used when the machine settings 12 are changed to ensure that the changed machine settings are accurate.

The present invention ensures that the machine will produce the exact desired results without marking or damaging the tube 10 whatsoever, thus completely eliminating any scrap material and waste from conventional practices.

Although several embodiments have been described in detail for purposes of illustration, various modifications may be made without departing from the scope and spirit of the invention. Accordingly, the invention is not to be limited, except as by the appended claims.

What is claimed is:

1. A system for measuring tube movement through a tube altering machine, comprising:
a first sensor device associated with a tube moving through the tube altering machine that detects a rotational movement of the tube caused by the tube altering machine; and
a second sensor device associated with the tube moving through the tube altering machine that detects a linear movement of the tube caused by the tube altering machine.

2. The system of claim 1, wherein the first sensor device detects rotational movement of the tube and the second sensor device detects linear movement of the tube over a predetermined period of time comprising between one second and one minute.

3. The system of claim 1, wherein the first and second sensor devices comprise electro-mechanical devices.

4. The system of claim 1, wherein the first and second sensor devices are communicatively coupled to an electronic device that determines if the detected rotational and/or linear movement of the tube through the tube altering machine differs from an expected rotational and/or linear movement of the tube over a predetermined period of time.

5. The system of claim 1, wherein the first sensor device comprises a driver roller engageable with a surface of the tube and a first encoder associated with the driver roller that detects rotation of the driver roller caused by rotation of the tube.

6. The system of claim 5, including a supporting roller engageable with the surface of the tube in spaced relation to the driver roller for supporting the tube between the support roller and the driver roller.

7. The system of claim 5, including a clamping device that selectively brings the driver roller into engagement with the surface of the tube.

8. The system of claim 1, wherein the second sensor device comprises a linear encoder device associated with the tube so as to detect a linear distance the tube travels over a predetermined period of time.

9. The system of claim 7, wherein the linear encoder device includes a retractable cable that extends from the encoder as the tube moves linearly.

10. The system of claim 7, wherein the linear encoder device is operably coupled to a vertical roll assembly, including a linear roller, that detects linear movement of the tube.

11. The system of claim 7, wherein a linear encoder housing is in fixed position relative to the tube and includes a retractable cable extendible from the linear encoder housing as a linear roller rotates in response to a linear movement of the tube.

12. The system of claim 11, wherein the linear roller is spaced apart from the tube and is attached to an arm that is coupled to the tube.

13. A method for measuring tube movement through a tube altering machine, comprising the steps of:
detecting a rotational movement of the tube caused by the tube altering machine as the tube passes therethrough over a predetermined period of time;
detecting a linear movement of the tube caused by the tube altering machine as the tube passes therethrough over the predetermined period of time; and
determining if adjustments should be made to the tube altering machine by comparing the detected rotational movement and linear movement of the tube over the predetermined period of time to an anticipated rotational movement and linear movement of the tube over the predetermined period of time.

14. The method of claim 13, wherein the predetermined period of time comprises between one second and one minute.

15. The method of claim 13, wherein the detecting rotational movement step comprises the step of associating a rotational sensor device with the tube to detect rotational movement of the tube, and wherein the detecting linear movement step comprises the step of associating a linear sensor device to measure the linear movement of the tube.

16. The method of claim 15, wherein the rotational sensor device and the linear rotational sensor device each comprise an electro-mechanical device.

17. The method of claim 15, wherein the rotational sensor device comprises a driver roller positionable onto a surface of the tube and an encoder operably connected to the driver roller.

18. The method of claim 15, wherein the linear sensor device comprises a retractable cable coupled to the tube and which extends from a fixed linear encoder as the tube moves linearly.

19. The method of claim 18, including a linear roller coupled to the retractable cable and the tube.
